(19) United States
(12) Patent Application Publication
(10) Pub. No.: US 2013/0026153 A1
(43) Pub. Date: Jan. 31, 2013

(54) LASER DICING METHOD

(71) Applicants: Mitsuhiro IDE, Shizuoka (JP); Makoto HAYASHI, Kanagawa (JP)

(72) Inventors: Mitsuhiro IDE, Shizuoka (JP); Makoto HAYASHI, Kanagawa (JP)

(21) Appl. No.: 13/556,668

(22) Filed: Jul. 24, 2012

(30) Foreign Application Priority Data
Jul. 27, 2011 (JP) 2011-164043
Sep. 8, 2011 (JP) 2011-195562

(51) Int. Cl. B23K 26/08

(52) U.S. Cl. 219/385

(57) ABSTRACT

Provided is a laser dicing method, including: loading a substrate on a stage; generating a clock signal; emitting a pulse laser beam synchronized to the clock signal; relatively shifting the substrate and the pulse laser beam; switching by the unit of an optical pulse irradiation and non-irradiation of the pulse laser beam to the substrate by controlling passage and interruption of the pulse laser beam by using a pulse picker in synchronization with the clock signal; and forming a crack reaching the surface of the substrate on the substrate, wherein the crack is formed to be continuous on the surface of the substrate by controlling irradiation energy of the pulse laser beam, a processing point depth of the pulse laser beam, and the lengths of an irradiation region and a non-irradiation region of the pulse laser beam.

### CROSS-REFERENCE TO RELATED APPLICATION

This application is based on and claims priority of Japanese Patent Application (JPA) No. 2011-164043, filed on Jul. 27, 2011 and Japanese Patent Application (JPA) No. 2011-195562, filed on Sep. 8, 2011, the entire contents of which are incorporated herein by reference.

### FIELD OF THE INVENTION

Embodiments described herein relate generally to a laser dicing method using a pulse laser beam.

### BACKGROUND OF THE INVENTION

A method of using a pulse laser beam in dicing a semiconductor substrate is disclosed in Japanese Patent No. 3867107. This method forms a reforming region in a workpiece by optical damage caused by the pulse laser beam. The workpiece is cut from the reforming region.

In the related art, forming the reforming region is controlled by using energy of the pulse laser beam, a spot diameter, a relative shift velocity between the pulse laser beam and the workpiece, and the like as parameters.

### SUMMARY OF THE INVENTION

A laser dicing method according to one aspect of the present embodiment includes: loading a substrate (or a workpiece) on a stage; generating a clock signal; emitting a pulse laser beam synchronized to the clock signal; relatively shifting the substrate and the pulse laser beam; switching by the unit of an optical pulse irradiation and non-irradiation of the pulse laser beam to the substrate by controlling passage and interruption of the pulse laser beam by using a pulse picker in synchronization with the clock signal; and forming a crack reaching a surface of the substrate on the substrate, wherein the crack is formed to be continuous on the surface of the substrate by controlling irradiation energy of the pulse laser beam, a processing point depth of the pulse laser beam, and the lengths of an irradiation region and a non-irradiation region of the pulse laser beam.

In the method according to the above aspect, the crack is formed on the surface of the substrate substantially linearly.

In the method according to the above aspect, the position of the substrate and an operation start position of the pulse picker are synchronized with each other.

In the method according to the above aspect, the substrate is a sapphire substrate, a crystal sapphire, or a glass substrate.

In the method according to the above aspect, the stage is shifted in synchronization with the clock signal to relatively shift the substrate and the pulse laser beam.

### BRIEF DESCRIPTION OF THE DRAWINGS

FIG. 1 is a schematic configuration diagram illustrating one example of a laser dicing apparatus used in a laser dicing method of an embodiment.

FIG. 2 is a diagram describing a timing control of the laser dicing method of the embodiment.

FIG. 3 is a diagram illustrating an operation of a pulse picker and the timing of a modulated pulse laser beam in the laser dicing method of the embodiment.

FIG. 4 is an explanatory diagram of an irradiation pattern in the laser dicing method of the embodiment.

FIG. 5 is a top view illustrating an irradiation pattern irradiated onto a sapphire substrate.

FIG. 6 is a cross-sectional view taken along line A-A of FIG. 5.

FIG. 7 is a diagram describing the relationship between the shift of a stage and dicing processing.

FIG. 8 is a diagram illustrating an irradiation pattern of Example 1.

FIGS. 9A to 9E are diagrams illustrating results of laser dicing of Examples 1 to 4 and Comparative Example 1.

FIG. 10 is a cross-sectional view illustrating the result of laser dicing of Example 1.

FIGS. 11A to 11F are diagrams illustrating results of laser dicing of Examples 5 to 10.

FIGS. 12A to 12E are diagrams illustrating results of laser dicing of Examples 11 to 15.

FIGS. 13A to 13F are diagrams illustrating results of laser dicing of Examples 16 to 21.

FIGS. 14A and 14B are explanatory diagrams when the crack is formed by scanning the pulse laser beam having different processing point depths on the same scanning line of a plurality of substrates.

FIGS. 15A and 15B are optical photographs of a fracture surface when the substrate is fractured under the conditions of FIGS. 14A and 14B.

FIGS. 16A to 16C are diagrams illustrating results of laser dicing of Examples 22 to 24.

FIGS. 17A to 17D are explanatory diagrams of an operation of the embodiment.

FIGS. 18A and 18B are diagrams illustrating results of laser dicing of Example 25.

FIG. 19 is a diagram illustrating results of laser dicing of Examples 26 to 28 and Comparative Examples 2 and 3.

### DETAILED DESCRIPTION OF THE INVENTION

Hereinafter, embodiments will be described with reference to the accompanying drawings. Further, in this specification, a processing point is a point around a light collecting position (focus position) in a substrate of a pulse laser beam and means a point where a reforming degree of the substrate becomes a maximum in a depth direction. A processing point depth means a depth of the processing point of the pulse laser beam from the surface of the substrate.

In a laser dicing method of the embodiment, the substrate is loaded on a stage, a clock signal is generated, a pulse laser beam synchronized to the clock signal is emitted, the substrate and the pulse laser beam are relatively shifted, irradiation and non-irradiation of the pulse laser beam to the substrate is switched by the unit of an optical pulse by controlling passage and interruption of the pulse laser beam in synchronization with the clock signal, an inner reforming region (inner reforming layer) is formed on the substrate, and a crack reaching the surface of the substrate is formed. By controlling irradiation energy of the pulse laser beam, a processing point depth of the pulse laser beam, and an interval between irradiation and non-irradiation of the pulse laser beam, the crack is formed to be continuous substantially linearly on the surface of the substrate.

A laser dicing method which implements an excellent fracture characteristic may be provided by the configuration. Herein, the excellent fracture (or cleaving) characteristic may include that (1) a fracture portion is fractured with high linearity, (2) a substrate may be fractured with small fracture force so as to improve a yield of a diced element, and (3) an element installed on the substrate, for example, an LED element formed as an epitaxial layer on the substrate may not be deteriorated due to an influence of a laser irradiated when an inner reforming area and a crack are formed.

The crack that is continuous on the surface of the substrate is formed, such that particularly, a hard substrate such as a sapphire substrate is easily diced. Dicing with a small dicing width is implemented.

A laser dicing apparatus of the embodiment that implements the laser dicing method includes a stage configured to place the substrate, a reference clock oscillating circuit configured to generate a clock signal, a laser oscillator configured to emit the pulse laser beam, a laser oscillator controlling unit configured to synchronize the pulse laser beam to the clock signal, a pulse picker installed on an optical path between the laser oscillator and the stage and configured to switch irradiation and non-irradiation of the pulse laser beam to the substrate, and a pulse picker controlling unit configured to control passage and interruption of the pulse laser beam in the pulse picker by the unit of an optical pulse in synchronization with the clock signal.

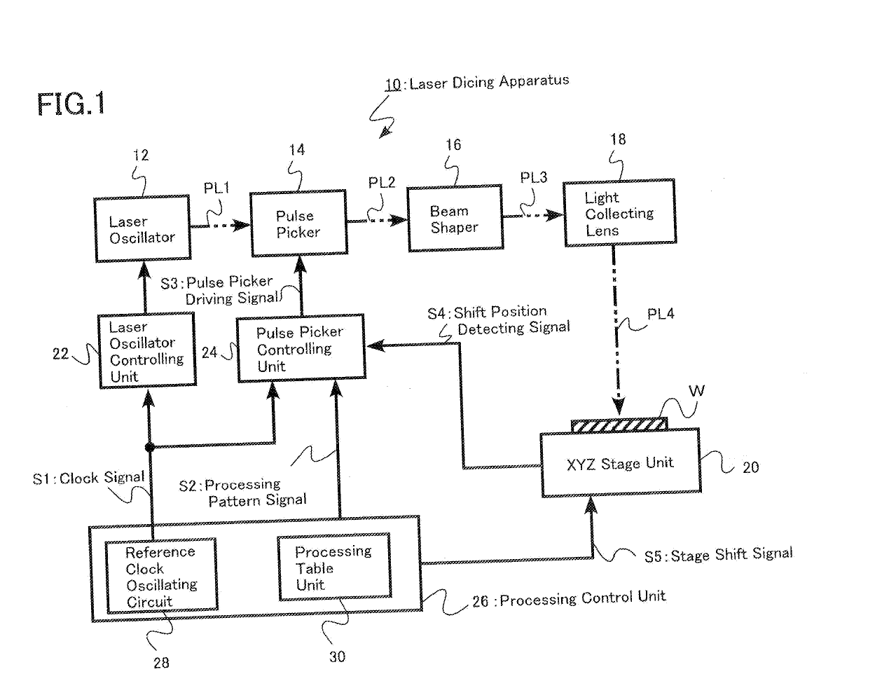

FIG. 1 is a schematic configuration diagram illustrating one example of a laser dicing apparatus of the embodiment. As illustrated in FIG. 1, a laser dicing apparatus 10 of the embodiment includes a laser oscillator 12, a pulse picker 14, a beam shaper 16, a light collecting lens (or a condenser lens) 18, an XYZ stage unit 20, a laser oscillator controlling unit 22, a pulse picker controlling unit 24, and a processing controlling unit 26 as primary components. A reference clock oscillating circuit 28 generating a desired clock signal S1 and a processing table unit 30 are provided in the processing controlling unit 26.

The laser oscillator 12 is configured to emit a pulse laser beam PL1 of a cycle Tc synchronized to the clock signal S1 generated from the reference clock oscillating circuit 28. The intensity of irradiated pulse light represents a Gaussian distribution. The clock signal S1 is a clock signal for processing control used to control laser dicing processing.

Herein, as a wavelength of the laser emitted from the laser oscillator 12, a wavelength with permeability to the substrate is used. As the laser, an Nd:YAG laser, an Nd:YVO₄ laser, an Nd:YLF laser, and the like maybe used. For example, when the substrate is a sapphire substrate, the Nd:YVO₄ laser having a wavelength of 532 nm is preferably used.

The pulse picker 14 is installed on an optical path between the laser oscillator 12 and the light collecting lens 18. By switching passage and interruption (on/off) of the pulse laser beam PL1 in synchronization with the clock signal S1, irradiation and non-irradiation of the pulse laser beam PL1 to the substrate is configured to be switched by the unit of the number of optical pulses. As described above, on/off of the pulse laser beam PL1 is controlled in order to process the substrate by an operation of the pulse picker 14 and becomes a modulated pulse laser beam PL2.

The pulse picker 14 is preferably configured by, for example, an acousto-optic modulator (AOM). For example, a Raman diffractive electro-optic modulator (EOM) may be used.

The beam shaper 16 shapes the incident pulse laser beam PL2 to a pulse laser beam PL3 shaped in a desired shape. For example, the beam shaper 16 is a beam expander that expands a beam diameter at a predetermined magnitude. For example, an optical element such as a homogenizer that homogenizes a light intensity distribution of a beam cross-section may also be provided. For example, an element that makes a beam cross-section be circle or an optical element that makes the beam be circular polarized light may be provided.

The light collecting lens 18 is configured to collect the pulse laser beam PL3 shaped by the beam shaper 16 and irradiate a pulse laser beam PL4 to a substrate W loaded on the XYZ stage unit 20, for example, a sapphire substrate with an LED formed on the bottom thereof.

The XYZ stage unit 20 includes an XYZ stage (hereinafter, simply referred to as a stage) that may be loaded with the substrate W and may be arbitrarily shifted in XYZ directions, a driving mechanism unit thereof, a position sensor with, for example, a laser interferometer that measures the position of the stage, and the like. Herein, the XYZ stage is configured such that positioning accuracy and a shift error thereof becomes high accuracy in a sub-micron range. A focus position of the pulse laser beam may be adjusted with respect to the substrate W by shifting the XYZ stage in a Z direction and a processing point depth may be controlled.

The processing controlling unit 26 wholly controls the processing by the laser dicing apparatus 10. The reference clock oscillating circuit 28 generates the desired clock signal S1. The processing table unit 30 stores a processing table in which dicing processing data is described as the number of optical pulses of the pulse laser beam.

Subsequently, the laser dicing method using the laser dicing apparatus 10 will be described with reference to FIGS. 1 to 7.

First, the substrate W, for example, the sapphire substrate is loaded on the XYX stage unit 20. The sapphire substrate is, for example, a wafer in which an epitaxially grown GaN layer is provided on the bottom thereof and a plurality of LEDs is patterned on the GaN layer. The wafer is aligned to the XYZ stage based on a notch or an orientation flat formed on the wafer.

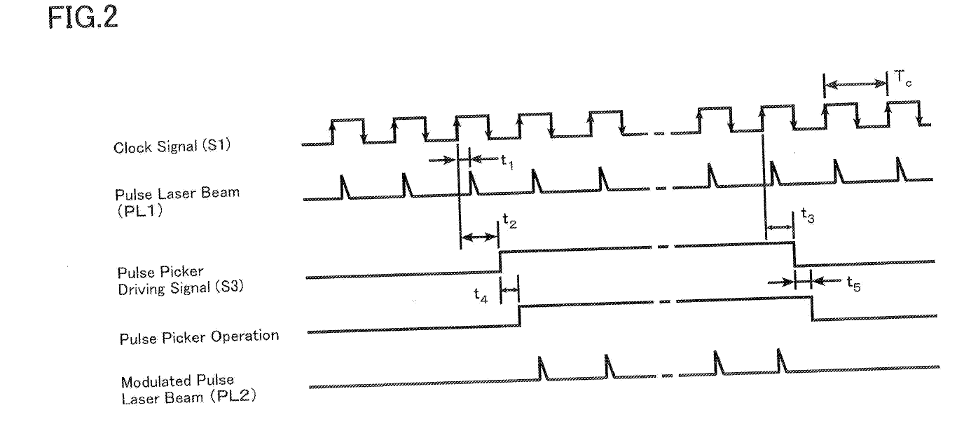

FIG. 2 is a diagram describing a timing control of the laser dicing method of the embodiment. In the reference clock oscillating circuit 28 in the processing controlling unit 26, the clock signal 51 of the cycle Tc is generated. The laser oscillator controlling unit 22 controls the laser oscillator 12 to emit the pulse laser beam PL1 of the cycle Tc synchronized to the clock signal S1. In this case, a delay time t₁ is generated between the rise in the clock signal S1 and the rise in the pulse laser beam.

As laser light, light having a wavelength with permeability to the substrate is used. Herein, laser light is preferably used, in which energy hv of a photon of the irradiated laser light is larger than a band gap Eg of absorption of a substrate material. When the energy hv is significantly larger than the band gap Eg, the laser light is absorbed. This is called multiphoton absorption, and when the multiphoton absorption is raised in the substrate by making a pulse width of the laser light very short, energy of the multiphoton absorption is not transformed to heat energy, and a persistent structural change such as ion valence variation, crystallization, amorphousness, polarization orientation, or formation of a minute crack is induced, such that a color center is formed.

Irradiation energy (irradiation power) of the laser light (pulse laser beam) selects an optimal condition in forming the continuous crack on the surface of the substrate.

When the wavelength having permeability is used for the substrate material, the laser light may be guided and collected around a focus in the substrate. Therefore, the color center may be locally established. The color center will be hereinafter referred to as a reforming region.

The pulse picker controlling unit 24 refers to a processing pattern signal S2 output from the processing controlling unit 26 and generates a pulse picker driving signal S3 synchronized to the clock signal S1. The processing pattern signal S2 is stored in the processing table unit 30 and is generated by referring to the processing table in which information on an irradiation pattern is described as the number of optical pulses by the optical pulse unit. The pulse picker 14 performs an operation of switching passage and interruption (on/off) of the pulse laser beam PL1 in synchronization with the clock signal S1 based on the pulse picker driving signal S3.

The modulated pulse laser beam PL2 is generated by the operation of the pulse picker 14. Further, delay times t₂ and t₃ are generated between the rise in the clock signal S1 and the rise and the drop in the pulse laser beam. Delay times t₄ and t₅ are generated between the rise and the drop in the pulse laser beam and the operation of the pulse picker.

When the substrate is processed, a generation timing of the pulse picker driving signal S3 or a relative shift timing between the substrate and the pulse laser beam is determined considering the delay times t₁ to t₅.

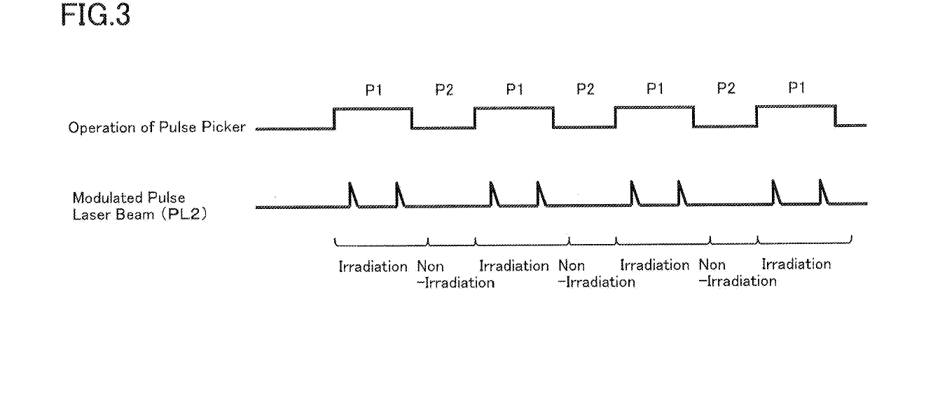

FIG. 3 is a diagram illustrating the operation of the pulse picker and the timing of the modulated pulse laser beam PL2 in the laser dicing method of the embodiment. The operation of the pulse picker is switched by the unit of the optical pulse in synchronization with the clock signal S1. As such, oscillation of the pulse laser beam and the operation of the pulse picker are synchronized to the same clock signal S1 to implement the irradiation pattern of the optical pulse unit.

Specifically, irradiation and non-irradiation of the pulse laser beam is performed based on a predetermined condition defined as the number of optical pulses. That is, the operation of the pulse picker is executed, and irradiation and non-irradiation to the substrate is switched, based on the number of irradiated optical pulses (P1) and the number of non-irradiated optical pulses (P2). The P1 value or P2 value that defines the irradiation pattern of the pulse laser beam is, for example, defined as an irradiation region register set or a non-irradiated region register set in the processing table. The P1 value or P2 value is set under a predetermined condition to optimize formation of the reforming region and crack while dicing by a material of the substrate, or a condition of the laser beam, and the like.

The modulated pulse laser beam PL2 is shaped to the pulse laser beam PL3 shaped in a desired shape by the beam shaper 16. The shaped pulse laser beam PL3 is collected by the light collecting lens 18 and becomes the pulse laser beam PL4 having a desired beam diameter, and is irradiated on the wafer as the substrate.

When the wafer is diced in an X-axis direction and a Y-axis direction, first, the pulse laser beam PL4 is scanned, for example, by shifting the XYZ stage in the X-axis direction at a predetermined velocity. After dicing in the desired x-axis direction ends, the pulse laser beam PL4 is scanned by shifting the XYZ stage in the Y-axis direction at a predetermined velocity. As a result, dicing in the Y-axis direction is performed.

The interval between irradiation and non-irradiation of the pulse laser beam is controlled by the number of irradiated optical pulses (P1), the number of non-irradiated optical pulses (P2), and the velocity of the stage.

In regard to a Z-axis direction (height direction), the light collecting position (focus position) of the light collecting lens is adjusted to be positioned at a predetermined depth in the wafer. The predetermined depth is set so that the reforming region (reforming layer) is formed during the dicing and the crack is formed on the surface of the substrate in a desired shape.

In this case, if

tropism rate of substrate: n,

processing position from the surface of the substrate: L, and

Z-axis shift distance: Lz,

Lz=L/n.

That is, in the case where when the light collecting position of the light collecting lens is processed at a position from the surface of the substrate by a depth ‘L’ when the surface of the substrate is set as a Z-axis initial position, a Z axis is shifted by ‘Lz’

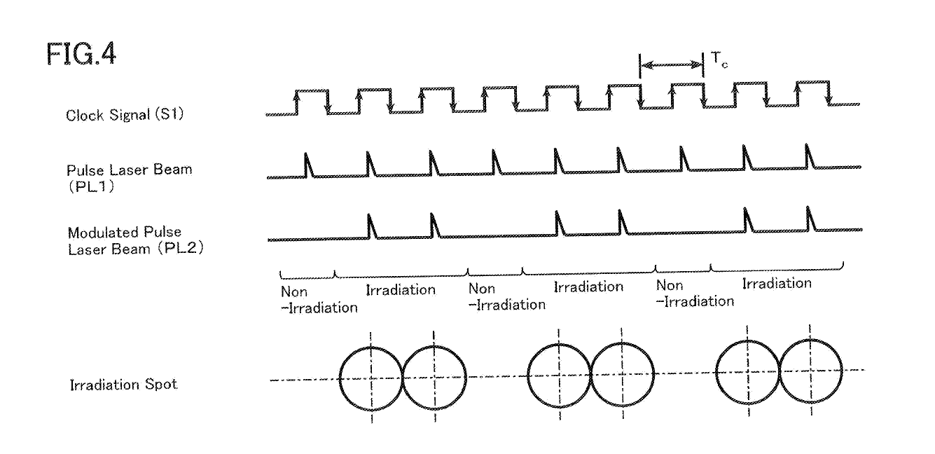

FIG. 4 is an explanatory diagram of the irradiation pattern in the laser dicing method of the embodiment. As illustrated in the figure, the pulse laser beam PL1 is generated in synchronization with the clock signal S1. By controlling passage and interruption of the pulse laser beam in synchronization with the clock signal S1, the modulated pulse laser beam PL2 is generated.

With horizontal (X-axis direction or Y-axis direction) shift of the stage, the irradiated optical pulse of the modulated pulse laser beam PL2 is formed on the wafer as an irradiation spot. As such, by generating the modulated pulse laser beam PL2, the irradiation spot is controlled on the wafer by the optical pulse unit and intermittently irradiated. In FIG. 4, a condition is set, in which the number of irradiated optical pulses (P1)=2 and the number of non-irradiated optical pulses, (P2)=1, and the irradiated optical pulse (Gaussian light) is repeatedly irradiated and non-irradiated at a pitch of the spot diameter.

Herein, when processing is performed under the conditions of

beam spot diameter: D (μm) and

repetition frequency: F (KHz),

the shift velocity V (m/sec) of the stage for the irradiated optical pulse to be repeatedly irradiated and non-irradiated at the pitch of the spot diameter is

V=D×10⁻⁶×F×10³.

For example, when processing is performed under the processing condition of

beam spot diameter: D=2 μm, and

repetition frequency: F=50 KHz,

the shift velocity of the stage is V=100 mm/sec.

When the power of irradiated light is P (watt), an optical pulse with irradiated pulse energy per pulse (P/F) is irradiated to the wafer.

Parameters such as the irradiation energy of the pulse laser beam (the power of the irradiated light), the processing point depth of the pulse laser beam, and the interval between irradiation and non-irradiation of the pulse laser beam are determined so that the crack is formed to be continuous on the surface of the substrate.

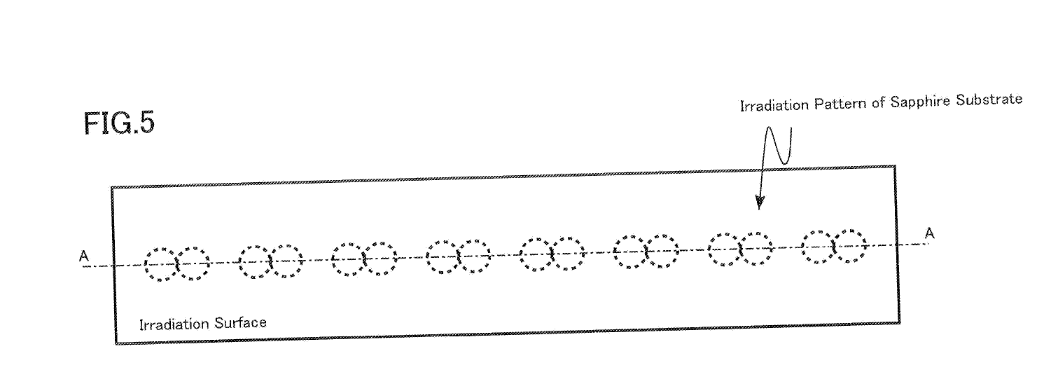

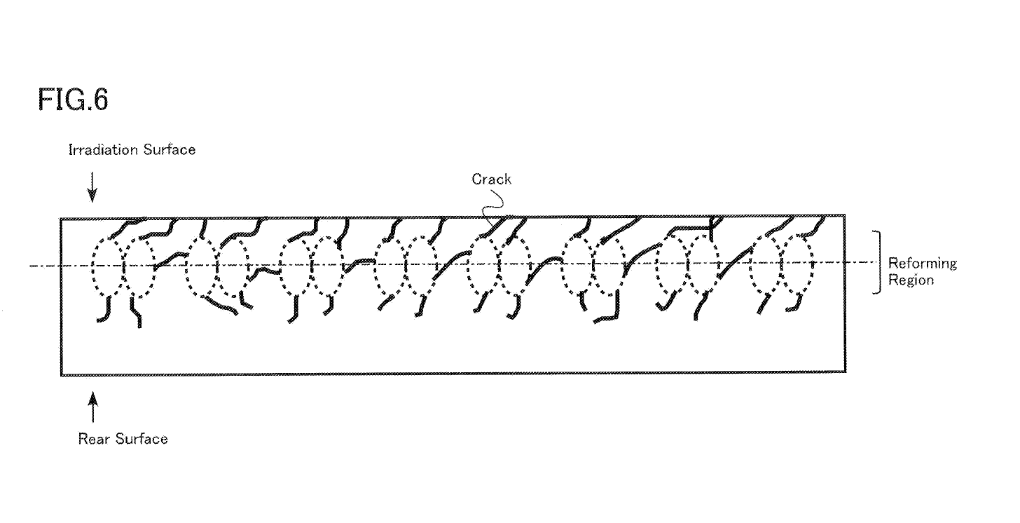

FIG. 5 is a top view illustrating an irradiation pattern irradiated onto the sapphire substrate. When viewed on an irradiation surface, the number of irradiated optical pulses (P1)=2 and the number of non-irradiated optical pulses (P2)=1, and the irradiation spot is formed at the pitch of the irradiation spot diameter. FIG. 6 is a cross-sectional view taken along line A-A of FIG. 5. As illustrated in the figure, the reforming region is formed in the sapphire substrate. The crack (alternatively, a groove) is formed, which reaches the surface of the substrate on a scanning line of the optical pulse from the reforming region. The crack is formed to be continuous on the surface of the substrate. In the embodiment, the crack is formed to be exposed to only the surface side of the substrate and does not reach a rear surface side of the substrate.

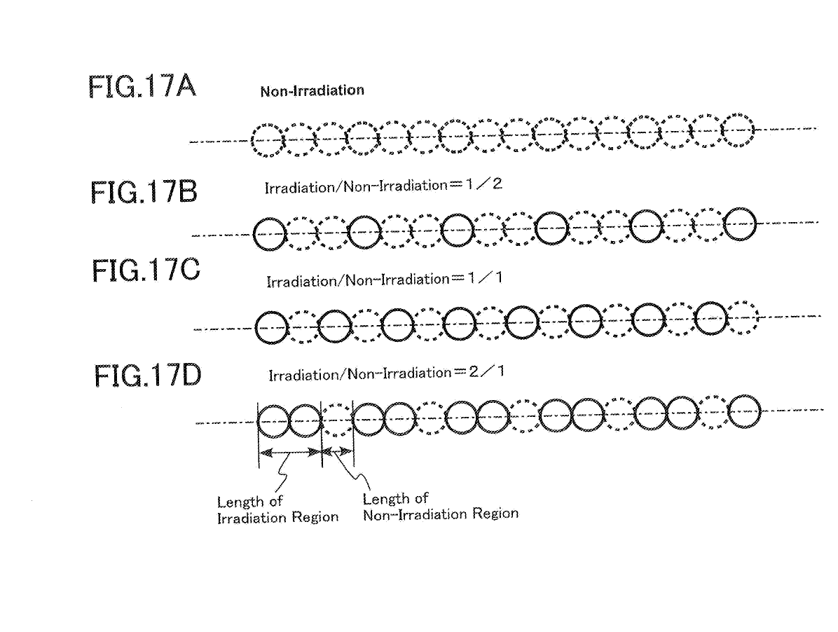

FIG. 17 is an explanatory diagram of an operation of the embodiment. For example, a pulse irradiatable position when a pulse laser is irradiated at the maximum laser frequency of the pulse laser beam which may be set and the highest velocity of stage which may be set is expressed in a dotted circle of FIG. 17A. FIG. 17B illustrates an irradiation pattern when irradiation/non-irradiation=1/2. A solid-line circle represents an irradiation position and the dotted circle is a non-irradiation position.

Herein, it is assumed that fracturality is high when the interval of the irradiation spot (the length of the non-irradiation region) is made to be shorter. In this case, as illustrated in FIG. 17C, handling is available by setting irradiation/non-irradiation=1/1 without changing the velocity of the stage. If the pulse picker is not used as in the embodiment, there are problems in that the velocity of the stage needs to be decreased in order to yield the same condition and a throughput of dicing processing deteriorates.

Herein, it is assumed that fracturality is high when the length of the irradiation region is made to be longer by forming the irradiation spot to be continuous. In this case, as illustrated in FIG. 17D, handling is available by setting irradiation/non-irradiation=2/1 without changing the velocity of the stage. If the pulse picker is not used as in the embodiment, there are problems in that the velocity of the stage needs to be decreased and further, the velocity of the stage needs to be changed, in order to yield the same condition and a throughput of dicing processing deteriorates and further, controlling becomes very difficult.

Alternatively, when the pulse picker is not used, a condition close to that of FIG. 17D is considered by increasing the irradiation energy with the irradiation pattern of FIG. 17B, but in this case, there is some concern in that laser power concentrated on one point increases, and the width of the crack increases or the linearity of the crack deteriorates. In the case of processing the substrate in which the LED element is formed on the sapphire substrate, there is some concern in that the amount of laser that reaches an LED region at an opposite side to the crack increases and the LED element deteriorates.

As such, according to the embodiment, for example, various fracture conditions may be implemented even if the condition of the pulse laser beam or the condition of the velocity of the stage is not changed, and the optimal fracture conditions may be discovered without deteriorating productivity or an element characteristic.

In the specification, ‘the length of the irradiation region’ and ‘the length of the non-irradiation region’ are set as the lengths illustrated in FIG. 17D.

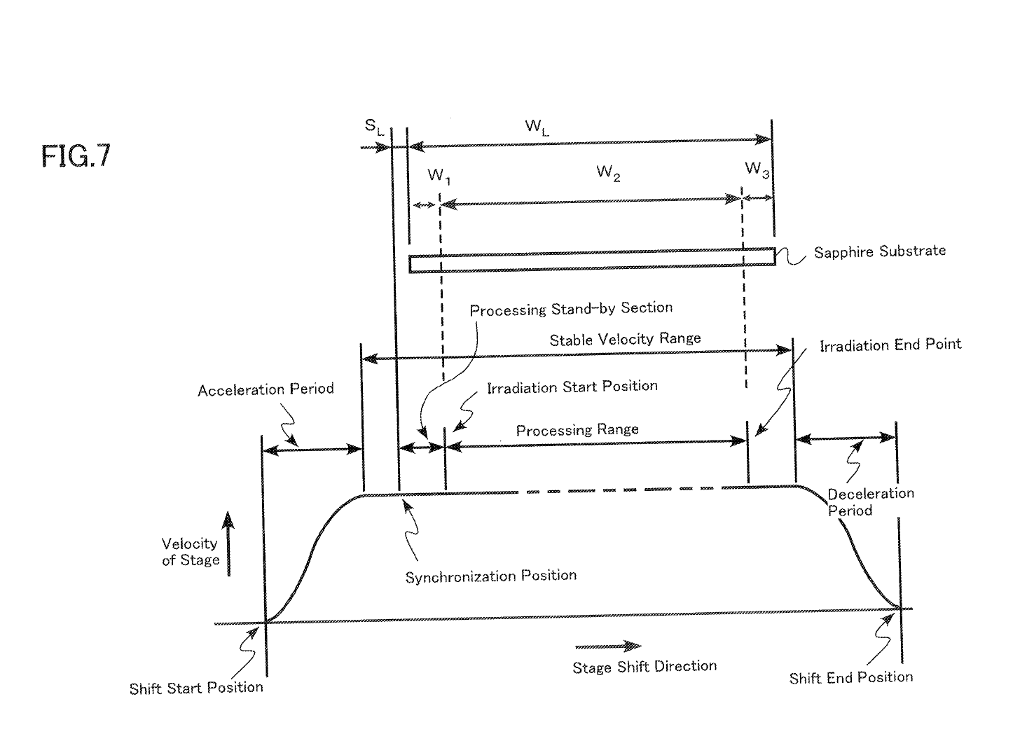

FIG. 7 is a diagram describing the relationship between the shift of the stage and dicing processing. A position sensor that detects the shift positions in the X-axis and the Y-axis directions is installed in the XYZ stage. For example, after starting the shift of the stage in the X-axis or Y-axis direction, a position where the velocity of the stage enters a stable velocity range is, in advance, set as a synchronization position. When the position sensor detects the synchronization position, for example, a shift position detection signal S4 (FIG. 1) is sent to the pulse picker controlling unit 24, and as a result, the operation of the pulse picker is permitted and the pulse picker is operated by the pulse picker driving signal S3. In the case of the synchronization position as, for example, a cross-section of the substrate, the cross-section may be detected by the position sensor.

As such,

S_{L}: distance from the synchronization position to the substrate,

W_{L}: processing length,

W₁: distance from a substrate end to an irradiation start position,

W₂: processing range, and

W₃: distance from an irradiation end position to the substrate end,

are managed.

As such, the position of the stage and the position of the substrate placed thereon, and the operation start position of the pulse picker are synchronized. That is, irradiation and non-irradiation of the pulse laser beam, and the position of the stage are synchronized. As a result, when the pulse laser beam is irradiated and non-irradiated, it is guaranteed that the stage is shifted at a predetermined velocity (in the stable velocity range). Accordingly, regularity of the irradiation spot position is guaranteed and the crack is stably formed.

Herein, when a thick substrate is processed, it is considered that the pulse laser beam having different processing point depths is scanned on the same scanning line of a plurality of (a plurality of layers of) substrates to form the crack, thereby improving the fracture characteristic. In this case, the position of the stage and the operation start position of the pulse picker are synchronized, such that the relationship of the pulse irradiation position may be arbitrarily controlled with high precision and a dicing condition may be optimized, in scanning with different depths.

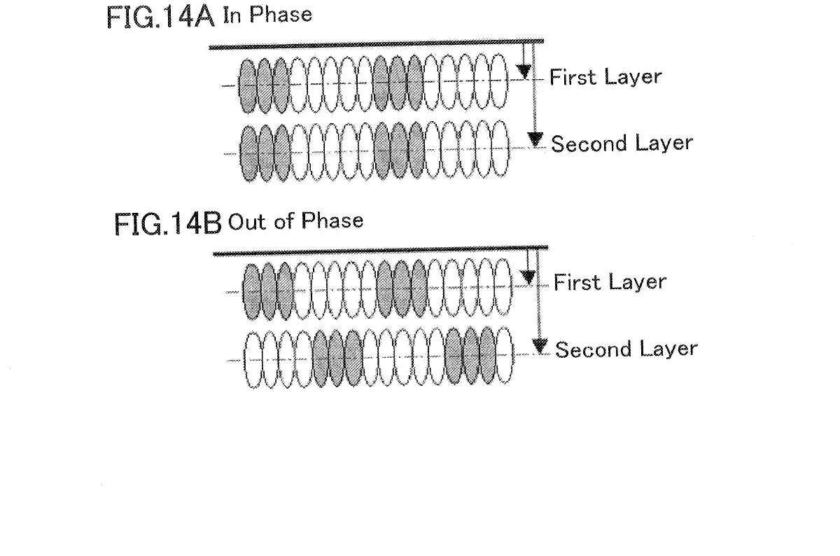

FIG. 14 is an explanatory diagram when the crack is formed by scanning the pulse laser beam having different processing point depths on the same scanning line of the plurality of substrates. FIG. 14 is a schematic diagram of the irradiation pattern on the cross-section of the substrate. ON (colored) is the irradiation region and OFF (white) is the non-irradiation region. FIG. 14A illustrates a case in which a first layer and a second layer of scanning of irradiation are in phase, that is, a case in which a vertical relationship of the positions of the irradiated pulses is provided on the first layer and the second layer. FIG. 14B illustrates a case in which the first layer and the second layer of scanning of irradiation are out of phase, that is, a case in which the vertical relationship of the positions of the irradiated pulses is deviated on the first layer and the second layer.

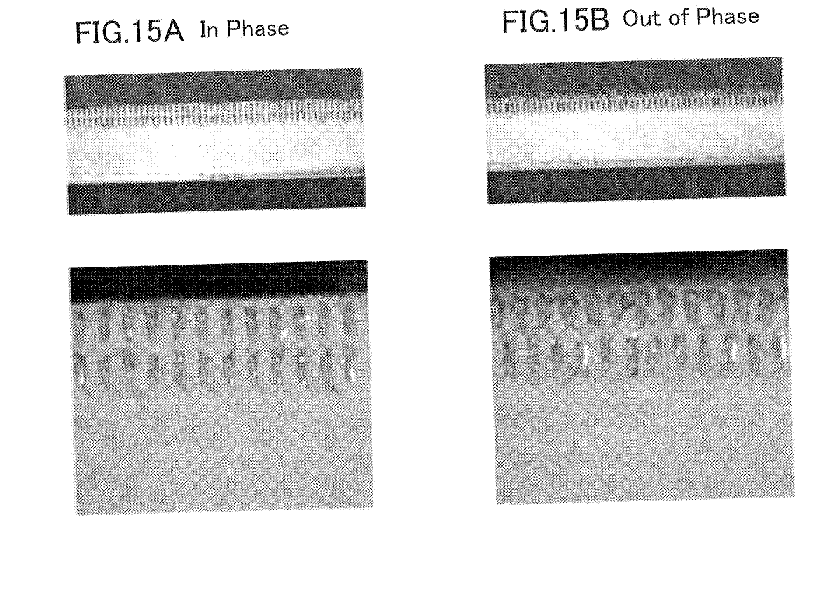

FIG. 15 is an optical photograph of a fracture surface in the case of fracturing under the condition of FIG. 14. FIG. 15A illustrates the in-phase case and FIG. 15B illustrates the out-of-phase case. In each figure, an upper photograph is configured in low magnitude and a lower photograph is configured in high magnitude. As such, the position of the stage and the operation start position of the pulse picker are synchronized, making it possible to control the relationship of scanning of irradiation on the first layer and the second layer with high precision.

The substrate illustrated in FIGS. 15A and 15B is a sapphire substrate having a thickness of 150 μm. In this case, fracture force required for fracturing is 0.31 N in the in-phase case and 0.38 N in the out-of-phase case, and the fracture characteristic is more excellent in the in-phase case.

Herein, the case in which the number of irradiation and non-irradiation pulses is the same on the first layer and the second layer is described as an example, but the optical condition may be discovered as the number of irradiation and non-irradiation pulses which is different on the first layer and the second layer.

For example, the shift of the stage is preferably synchronized to the clock signal to further improve the precision of the irradiation spot position. This may be achieved, for example, by synchronizing a stage shift signal S5 (FIG. 1) sent to the XYZ stage unit 20 from the processing controlling unit 26 to the clock signal S1.

As in the laser dicing method of the embodiment, by forming the reforming region, the crack, which reaches the surface of the substrate and further, is continuous on the surface of the substrate, is formed to easily fracture a subsequent substrate. For example, even on the hard substrate such as the sapphire substrate, force is artificially applied by using the crack that reaches the surface of the substrate as a start point of fracturing or cutting, making it possible to ease fracturing and achieve the excellent fracture characteristic. Accordingly, the productivity of dicing is improved.

In a method of continuously irradiating the pulse laser beam to the substrate in the related art, even though the shift velocity of the stage, the number of apertures of the light collecting lens, the power of irradiated light, and the like are optimized, it is difficult to control the crack that is formed to be continuous on the surface of the substrate in the desired shape. As in the embodiment, irradiation and non-irradiation of the pulse laser beam is intermittently switched by the unit of the optical pulse to optimize the irradiation pattern, and as a result, the laser dicing method is achieved, in which the formation of the reforming area and the generation of the crack reaching the surface of the substrate are controlled and the excellent fracture characteristic is provided.

That is, for example, a crack having a small width, which is continuous substantially linearly along the scanning line of the laser, may be formed on the surface of the substrate. By forming the crack which is continuous substantially linearly, it is possible to minimize the influence of the crack exerted on the device such as the LED formed on the substrate while dicing. For example, since the linear crack may be formed, the width of the region where the crack is formed on the surface of the substrate may be decreased. As a result, the width of dicing in design may be decreased. Accordingly, the number of chips of the device formed on the same substrate or wafer may be increased and the manufacturing cost of the device may also be reduced.

Hereinabove, the embodiment has been described with reference to the detailed examples. However, the embodiment is not limited to these detailed examples. In the embodiment, parts, which are directly unnecessary for describing the embodiment are not described in the laser dicing method and the laser dicing apparatus, but necessary components associated with the laser dicing method and the laser dicing apparatus may be appropriately selected and used.

All laser dicing methods which includes the components of the embodiment and those skilled in the art may appropriately design and change are included in the scope of the embodiment. The scope of the embodiment is defined by the scope of the appended claims and the scope equivalent thereto.

For example, in the embodiment, as the substrate, the sapphire substrate where the LED is formed is described as an example. The embodiment is useful in the substrate, which is hard, lacks in cleavage, and is difficult to fracture, such as the sapphire substrate, but the substrate may be other substrates, for example, a semiconductor material substrate such as a SiC (silicon carbon) substrate, a piezoelectric material substrate, a crystal substrate, a glass substrate such as a quartz glass.

In the embodiment, the case in which the substrate and the pulse laser beam are relatively shifted by shifting the stage is described as an example. However, for example, a method may be used, in which the substrate and the pulse laser beam are relatively shifted by scanning the pulse laser beam with a laser beam scanner.

In the embodiment, the case in which the number of irradiated optical pulses (P1)=2 and the number of non-irradiated optical pulses (P2)=1 is described as an example, but as the values of P1 and P2, arbitrary values may be used in order to achieve the optimal condition. In the embodiment, the case in which the irradiated optical pulse is repeatedly irradiated and non-irradiated at the pitch of the spot diameter is described as an example, but the pulse frequency or the stage shift velocity is changed, making it possible to find the optimal condition by changing pitches of irradiation and non-irradiation. For example, the pitches of irradiation and non-irradiation may be 1/n or n times larger than the spot diameter.

In particular, when the substrate is the sapphire substrate, the irradiation energy is set 30 mW or more and 150 mW or less, and the interval of irradiation is set in the range of 1 to 6 μm by setting the passage of the pulse laser beam by the unit of 1 to 4 optical pulses and setting the interruption thereof by the unit of 1 to 4 optical pulses, making it possible to form the crack which has excellent continuity and linearity on the surface of the substrate.

For the pattern of dicing processing, it is possible to copy with various dicing processing patterns by installing a plurality of irradiation region registers and a plurality of non-irradiation region registers or changing values of the irradiation region registers and the non-irradiation region registers to desired values at a desired timing in real time.

As the laser dicing apparatus, an apparatus including the processing table unit storing the processing table in which dicing processing data is described as the number of optical pulses of the pulse laser beam is described as an example. However, the laser dicing apparatus may be an apparatus having a component that controls the passage and the interruption in the pulse picker of the pulse laser beam by the unit of the optical pulse without the processing table unit.

In order to further improve the fracture characteristic, after the reforming region and the crack to be continuous on the surface of the substrate are formed, for example, melt processing or ablation processing may be added to the surface by irradiating the laser.

### EXAMPLES

Hereinafter, examples of the embodiment will be described.

### Example 1

Laser dicing is performed by a method disclosed in the embodiment, under the conditions below.

Substrate: sapphire substrate, thickness of substrate of 100 μm

Laser light source: Nd:YVO₄ laser

Wavelength: 532 nm

Irradiation energy: 50 mW

Laser frequency: 20 KHz

Number of irradiated optical pulses (P1): 1

Number of non-irradiated optical pulses (P2): 2

Velocity of stage: 25 mm/sec

Depth of the processing point: Approximately 25.2 μm from the surface of the substrate

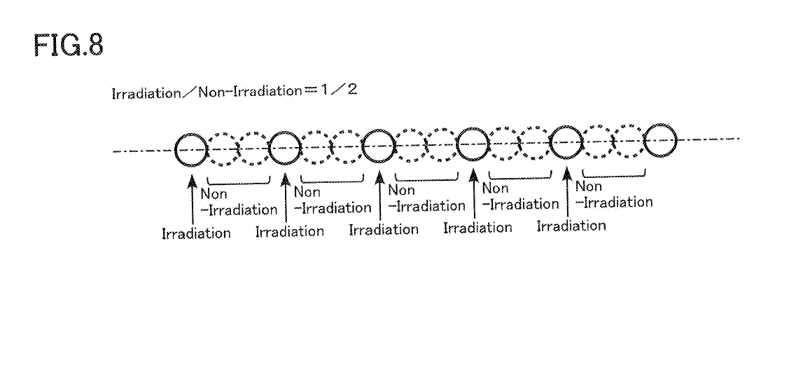

FIG. 8 is a diagram illustrating the irradiation pattern of Example 1. As illustrated in the figure, the optical pulse is irradiated once and the optical pulse as large as two pulses is non-irradiated by the unit of the optical pulse. This condition will now be described in a format of irradiation/non-irradiation=1/2. Herein, the pitches of irradiation and non-irradiation are the same as the spot diameter.

In Example 1, the spot diameter is approximately 1.2 μm. Therefore, the interval of irradiation is approximately 3.6 μm.

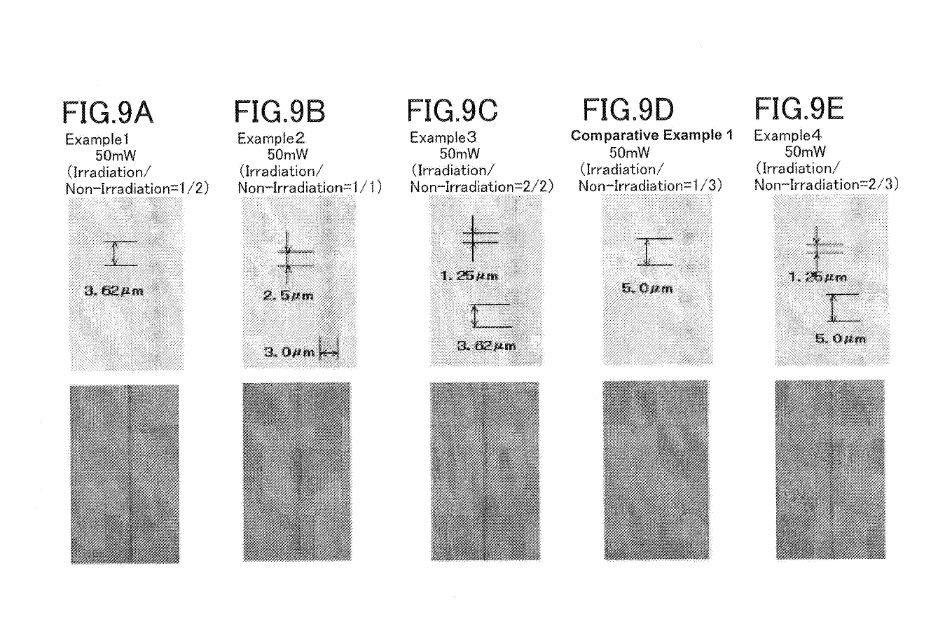

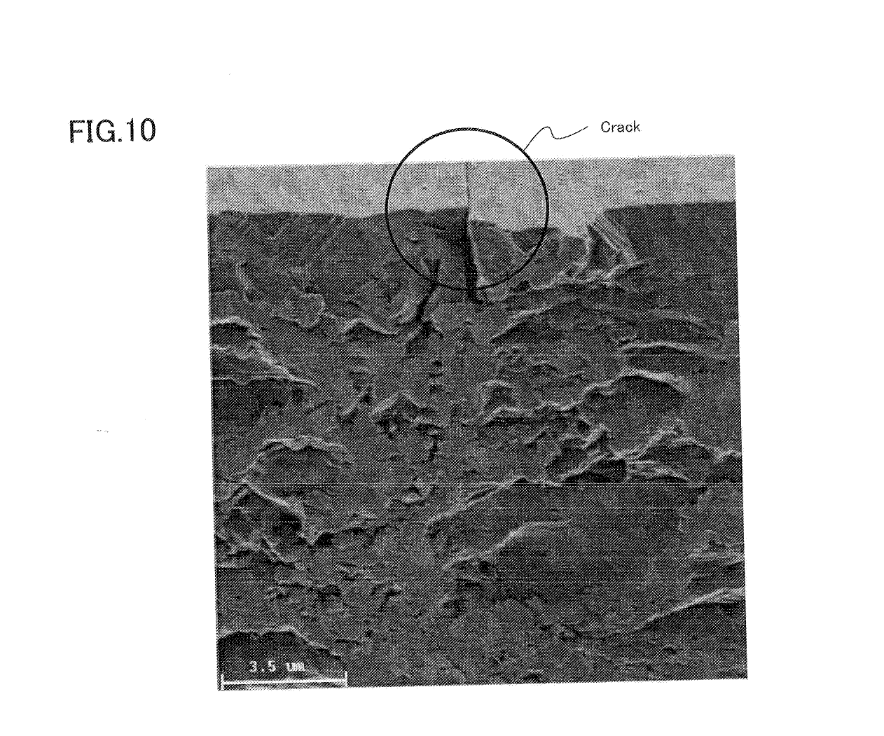

A result of laser dicing is illustrated in FIG. 9A. An upper optical photograph is acquired by focusing and photographing the reforming region in the substrate. A lower optical photograph is acquired by focusing and photographing the crack on the surface of the substrate. FIG. 10 is a cross-sectional SEM photograph of the substrate vertical to the direction of the crack.

The substrate has a reed shape having a width of approximately 5 mm and the crack is formed by irradiating the pulse laser beam vertically in an extension direction of a reed. After the crack is formed, the fracture force required for fracturing is evaluated by using a breaker.

### Example 2

Laser dicing is performed in the same method as in Example 1 except for irradiation/non-irradiation=1/1. A result of laser dicing is illustrated in FIG. 9B. An upper optical photograph is acquired by focusing and photographing the reforming region in the substrate. A lower optical photograph is acquired by focusing and photographing the crack on the surface of the substrate.

### Example 3

Laser dicing is performed in the same method as in Example 1 except for irradiation/non-irradiation=2/2. A result of laser dicing is illustrated in FIG. 9C. An upper optical photograph is acquired by focusing and photographing the reforming region in the substrate. A lower optical photograph is acquired by focusing and photographing the crack on the surface of the substrate.

### Example 4

Laser dicing is performed in the same method as in Example 1 except for irradiation/non-irradiation=2/3. A result of laser dicing is illustrated in FIG. 9E. An upper optical photograph is acquired by focusing and photographing the reforming region in the substrate. A lower optical photograph is acquired by focusing and photographing the crack on the surface of the substrate.

### Comparative Example 1

Laser dicing is performed in the same method as in Example 1 except for irradiation/non-irradiation=1/3. A result of laser dicing is illustrated in FIG. 9D. An upper optical photograph is acquired by focusing and photographing the reforming region in the substrate. A lower optical photograph is acquired by focusing and photographing the crack on the surface of the substrate.

In Examples 1 to 4, by setting the irradiation energy of the pulse laser beam, the processing point depth, and the interval between irradiation and non-irradiation as described above, the crack to be continuous on the surface of the substrate may be formed as illustrated in FIGS. 9 and 10.

In particular, in the condition of Example 1, the very linear crack is formed on the surface of the substrate. As a result, the linearity of a fractured portion after fracturing is also excellent. The substrate may be fractured with the smallest fracture force in the condition of Example 1. Therefore, when the substrate is the sapphire substrate, the irradiation energy is set to 50±5 mW, the processing point depth is set to 25.0±2.5 μm, and the passage of the pulse laser beam is set by the unit of one optical pulse and the interruption of the pulse laser beam is set by the unit of two optical pulses, such that the interval of irradiation is preferably 3.6±0.4 μm, by considering controllability of each condition.

Meanwhile, as in Example 3, when the reforming region is approached and the crack is formed between the reforming regions in the substrate, the crack on the surface is meandered and the width of the region where the crack is generated tends to increase. The reason is that the power of the laser light concentrated on a narrow region is very high.

In Comparative Example 1, the condition is not optimized and the crack to be continuous on the surface of the substrate is not formed. Therefore, evaluation on the fracture force is also impossible.

### Example 5

Laser dicing is performed by a method disclosed in the embodiment, under the conditions below.

Substrate: sapphire substrate, thickness of substrate of 100 μm

Laser light source: Nd:YVO4 laser

Wavelength: 532 nm

Irradiation energy: 90 mW

Laser frequency: 20 KHz

Number of irradiated optical pulses (P1): 1

Number of non-irradiated optical pulses (P2): 1

Velocity of stage: 25 mm/sec

Depth of processing point: Approximately 25.2 μm from the surface of the substrate.

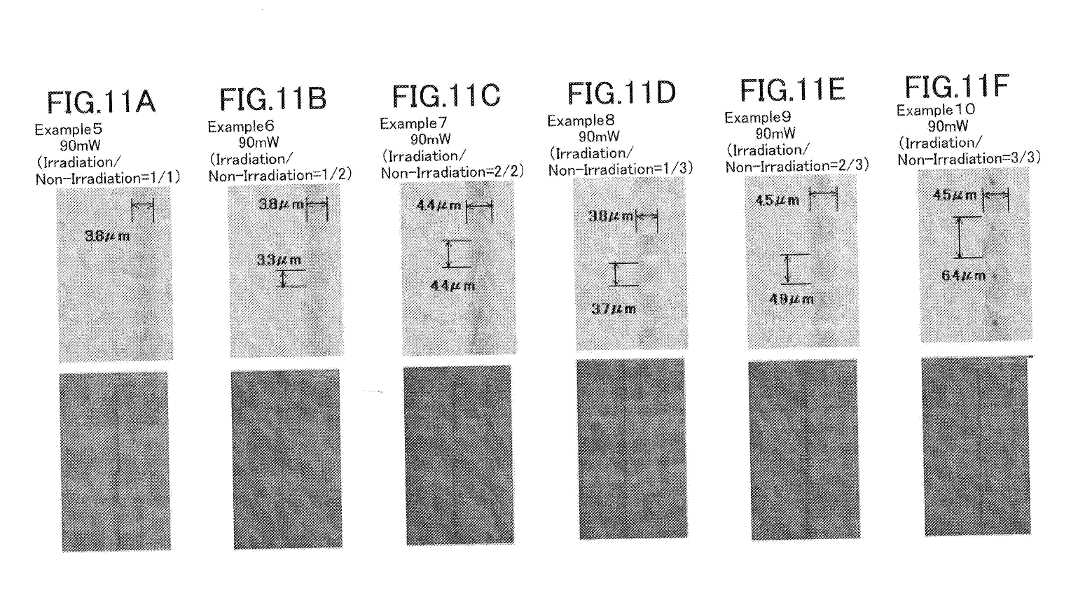

A result of laser dicing is illustrated in FIG. 11A. An upper optical photograph is acquired by focusing and photographing the reforming region in the substrate. A lower optical photograph is acquired by focusing and photographing the crack on the surface of the substrate.

### Example 6

Laser dicing is performed in the same method as in Example 1 except for irradiation/non-irradiation=1/2. A result of laser dicing is illustrated in FIG. 11B. An upper optical photograph is acquired by focusing and photographing the reforming region in the substrate. A lower optical photograph is acquired by focusing and photographing the crack on the surface of the substrate.

### Example 7

Laser dicing is performed in the same method as in Example 5 except for irradiation/non-irradiation=2/2. A result of laser dicing is illustrated in FIG. 11C. An upper optical photograph is acquired by focusing and photographing the reforming region in the substrate. A lower optical photograph is acquired by focusing and photographing the crack on the surface of the substrate.

### Example 8

Laser dicing is performed in the same method as in Example 5 except for irradiation/non-irradiation=1/3. A result of laser dicing is illustrated in FIG. 11D. An upper optical photograph is acquired by focusing and photographing the reforming region in the substrate. A lower optical photograph is acquired by focusing and photographing the crack on the surface of the substrate.

### Example 9

Laser dicing is performed in the same method as in Example except for irradiation/non-irradiation=2/3. A result of laser dicing is illustrated in FIG. 11E. An upper optical photograph is acquired by focusing and photographing the reforming region in the substrate. A lower optical photograph is acquired by focusing and photographing the crack on the surface of the substrate.

### Example 10

Laser dicing is performed in the same method as in Example 5 except for irradiation/non-irradiation=2/3. A result of laser dicing is illustrated in FIG. 11F. An upper optical photograph is acquired by focusing and photographing the reforming region in the substrate. A lower optical photograph is acquired by focusing and photographing the crack on the surface of the substrate.

In Examples 5 to 10, by setting the irradiation energy of the pulse laser beam, the processing point depth, and the interval between irradiation and non-irradiation as described above, the crack to be continuous on the surface of the substrate may be formed as illustrated in FIG. 11.

In particular, in the condition of Example 8, a comparatively linear crack is formed on the surface of the substrate. In the condition of Example 8, the fracture force is also small. However, as compared with the case in which the irradiation energy of Examples 1 to 4 is 50 mW, the crack of the surface is meandered and the width of the region where the crack is generated tends to increase. As a result, the linearity of the fractured portion is also more excellent in the case of 50 mW. The reason is that in the case of 90 mW, the power of the laser light concentrated on the narrow region is still larger than that in the case of 50 mW.

### Example 11

Laser dicing is performed by a method disclosed in the embodiment, under the conditions below.

Substrate: sapphire substrate, thickness of substrate of 100 μm

Laser light source: Nd:YVO₄ laser

Wavelength: 532 nm

Irradiation energy: 50 mW

Laser frequency: 20 KHz

Number of irradiation optical pulses (P1): 1

Number of non-irradiated optical pulses (P2): 2

Velocity of stage: 25 mm/sec

Depth of processing point: Approximately 15.2 μm from the surface of the substrate.

Dicing processing is performed under a condition in which the processing point depth is smaller than that of Example 1 by 10 μm, that is, a condition in which the light collecting position of the pulse laser beam is closer to the surface of the substrate than that as in Example 1.

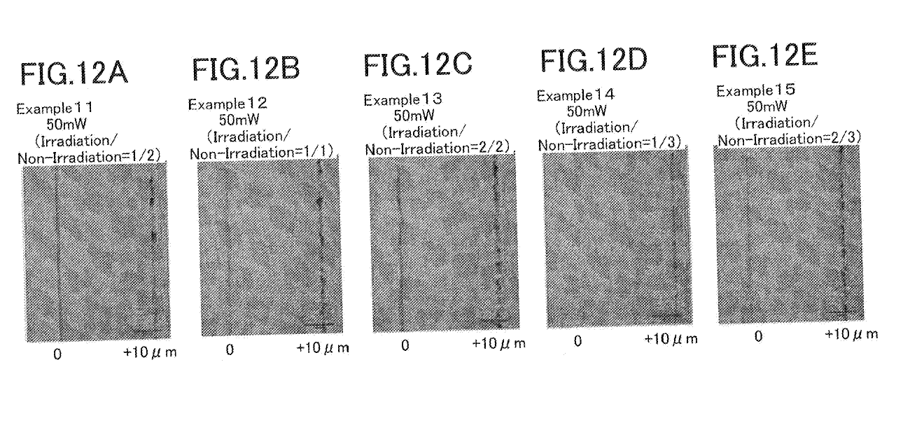

A result of laser dicing is illustrated in FIG. 12A. The surface of the substrate is focused and photographed. In the photograph, a right line (+10 μm) is a condition of Example 11. For comparison, a condition (0) of Example 1 which is different in only the processing point depth is illustrated at a left side.

### Example 12

Laser dicing is performed in the same method as in Example 11 except for irradiation/non-irradiation=1/1. A result of laser dicing is illustrated in FIG. 12B.

### Example 13

Laser dicing is performed in the same method as in Example 11 except for irradiation/non-irradiation=2/2. A result of laser dicing is illustrated in FIG. 12C.

### Example 14

Laser dicing is performed in the same method as in Example 11 except for irradiation/non-irradiation=1/3. A result of laser dicing is illustrated in FIG. 12D.

### Example 15

Laser dicing is performed in the same method as in Example 11 except for irradiation/non-irradiation=2/3. A result of laser dicing is illustrated in FIG. 12E.

In Examples 11 to 15, by setting the irradiation energy of the pulse laser beam, the processing point depth, and the interval between irradiation and non-irradiation as described above, the crack to be continuous on the surface of the substrate may be formed as illustrated in FIG. 12.

However, as compared with the case of Examples 1 to 4, a large crack in the reforming region is exposed to the surface. The crack on the surface is meandered and the width of the region where the crack is generated tends to increase.

### Example 16

Laser dicing is performed by a method disclosed in the embodiment, under the conditions below.

Substrate: sapphire substrate

Laser light source: Nd:YVO₄ laser

Wavelength: 532 nm

Irradiation energy: 90 mW

Laser frequency: 20 KHz

Number of irradiated optical pulses (P1): 1

Number of non-irradiated optical pulses (P2): 1

Velocity of stage: 25 mm/sec

Depth of processing point: Approximately 15.2 μm from the surface of the substrate.

Dicing processing is performed under a condition in which the processing point depth is smaller than that of Example 5 by 10 μm, that is, a condition in which the light collecting position of the pulse laser beam is closer to the surface of the substrate than that as in Example 5.

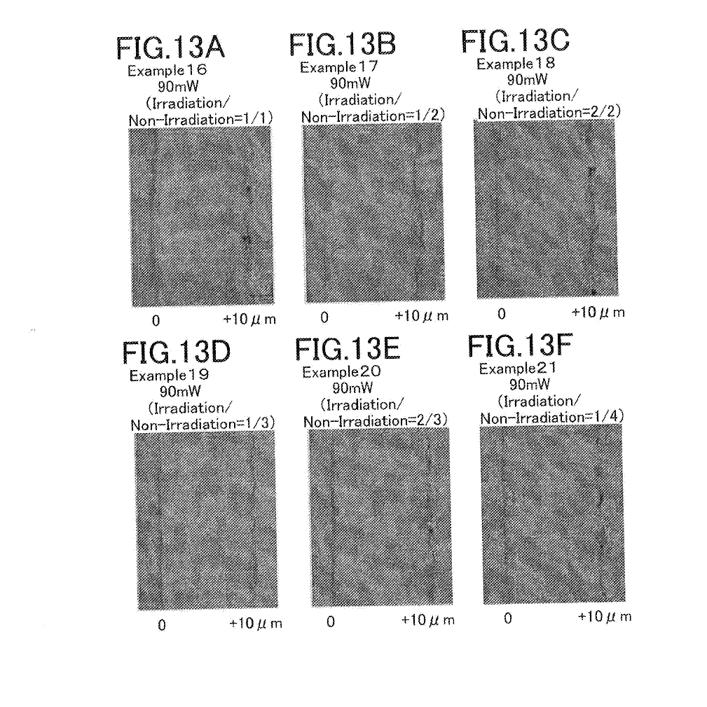

A result of laser dicing is illustrated in FIG. 13A. The reforming region in the substrate is focused and photographed. In the photograph, the right line (+10 μm) is a condition of Example 16. For comparison, the condition (0) of Example 5 which is different in only the processing point depth is illustrated at the left side.

### Example 17

Laser dicing is performed in the same method as in Example 16 except for irradiation/non-irradiation=1/2. A result of laser dicing is illustrated in FIG. 13B.

### Example 18

Laser dicing is performed in the same method as in Example 16 except for irradiation/non-irradiation=2/2. A result of laser dicing is illustrated in FIG. 13C.

### Example 19

Laser dicing is performed in the same method as in Example 16 except for irradiation/non-irradiation=1/3. A result of laser dicing is illustrated in FIG. 13D.

### Example 20

Laser dicing is performed in the same method as in Example 16 except for irradiation/non-irradiation=2/3. A result of laser dicing is illustrated in FIG. 13(e).

### Example 21

Laser dicing is performed in the same method as in Example 16 except for irradiation/non-irradiation=1/4. A result of laser dicing is illustrated in FIG. 13F.

In Examples 16 to 21, by setting the irradiation energy of the pulse laser beam, the processing point depth, and the interval between irradiation and non-irradiation as described above, the crack to be continuous on the surface of the substrate may be formed as illustrated in FIG. 13.

However, as compared with the case of Examples 5 to 10, the large crack in the reforming region is exposed to the surface. The crack on the surface is meandered and the width of the region where the crack is generated tends to increase. Therefore, the fractured portion after fracturing is also meandered.

Hereinabove, from the evaluation on Examples 1 to 21 and Comparative Example 1, it is apparent that the linearity of the fractured portion is excellent because the linearity of the crack is excellent and the condition of Example 1 in which the fracture force is also small is optimal when the thickness of the substrate is 100 μm.

### Example 22

Laser dicing is performed by a method disclosed in the embodiment, under the conditions below.

Substrate: sapphire substrate, thickness of substrate of 150 μm

Laser light source: Nd:YVO₄ laser

Wavelength: 532 nm

Irradiation energy: 200 mW

Laser frequency: 200 KHz

Number of irradiation optical pulses (P1): 1

Number of non-irradiated optical pulses (P2): 2

Velocity of stage: 5 mm/sec

Depth of processing point: Approximately 23.4 μm from the surface of the substrate.

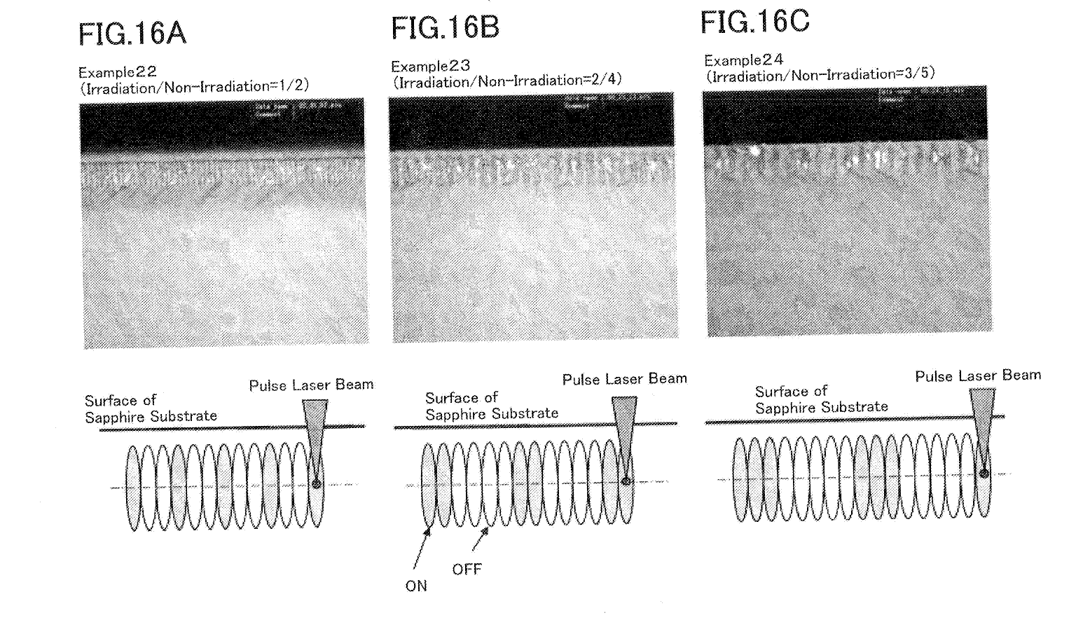

The substrate is the sapphire substrate having the thickness of 100 μm in Examples 1 to 21, while the substrate is the sapphire substrate having the thickness of 150 μm in the Example. A result of laser dicing is illustrated in FIG. 16A. An upper side is an optical photograph of a fracture surface of the substrate and a lower side is a schematic diagram of the irradiation pattern on the cross-section of the substrate. ON (colored) is the irradiation region and OFF (white) is the non-irradiation region.

The substrate has a reed shape having a width of approximately 5 mm and the crack is formed by irradiating the pulse laser beam vertically in an extension direction of a reed. After the crack is formed, the fracture force required for fracturing is evaluated by using the breaker.

### Example 23

Laser dicing is performed in the same method as in Example 22 except for irradiation/non-irradiation=2/4. A result of laser dicing is illustrated in FIG. 16B.

### Example 24

Laser dicing is performed in the same method as in Example 22 except for irradiation/non-irradiation=3/5. A result of laser dicing is illustrated in FIG. 16C.

The linearity of the crack is the same degree as that of Examples 22 to 23 and the linearity of the fractured portion after fracturing is the same degree. Fracture force required for fracturing of Example 22 is in the range from 2.39 N to 2.51 N, fracture force required for fracturing of Example 23 is in the range from 2.13 N to 2.80 N, and fracture force required for fracturing of Example 24 is in the range from 1.09 N to 1.51 N. As a result, it can be seen that the fracture force required for fracturing is the smallest under the condition of Example 24 in which irradiation/non-irradiation=3/5. Therefore, when the thickness of the substrate is 150 μm, it is apparent that the condition of Example 24 is optimal.

Hereinabove, from the Examples, it is apparent that, even though the thickness of the substrate is changed, when irradiation and non-irradiation of the pulse laser beam are synchronized with the pulse laser beam in addition to the irradiation energy of the pulse laser beam, the processing point depth of the pulse laser beam, and the like, irradiation and non-irradiation are controlled in synchronization with the clock signal for the same processing control and are switched by the unit of the optical pulse, and as a result, the optimal fracture characteristic may be achieved.

The cases in which the thicknesses of the substrates are 100 μm and 150 μm are exemplified in the Examples, but the optimal fracture characteristic may be implemented even in substrates having thicknesses of 200 μm and 250 μm which are thicker.

### Example 25

Laser dicing is performed by a method disclosed in the embodiment, under the conditions below.

Substrate: crystal substrate, the thickness of the substrate of 100 μm

Laser light source: Nd:YVO₄ laser

Wavelength: 532 nm

Irradiation energy: 250 mW

Laser frequency: 100 KHz

Number of irradiation optical pulses (P1): 3

Number of non-irradiated optical pulses (P2): 3

Velocity of stage: 5 mm/sec

Depth of processing point: Approximately 10 μm from the surface of the substrate.

The substrate has a reed shape having a width of approximately 5 mm and the crack is formed by irradiating the pulse laser beam vertically in an extension direction of a reed. After the crack is formed, the substrate is fractured by using the breaker.

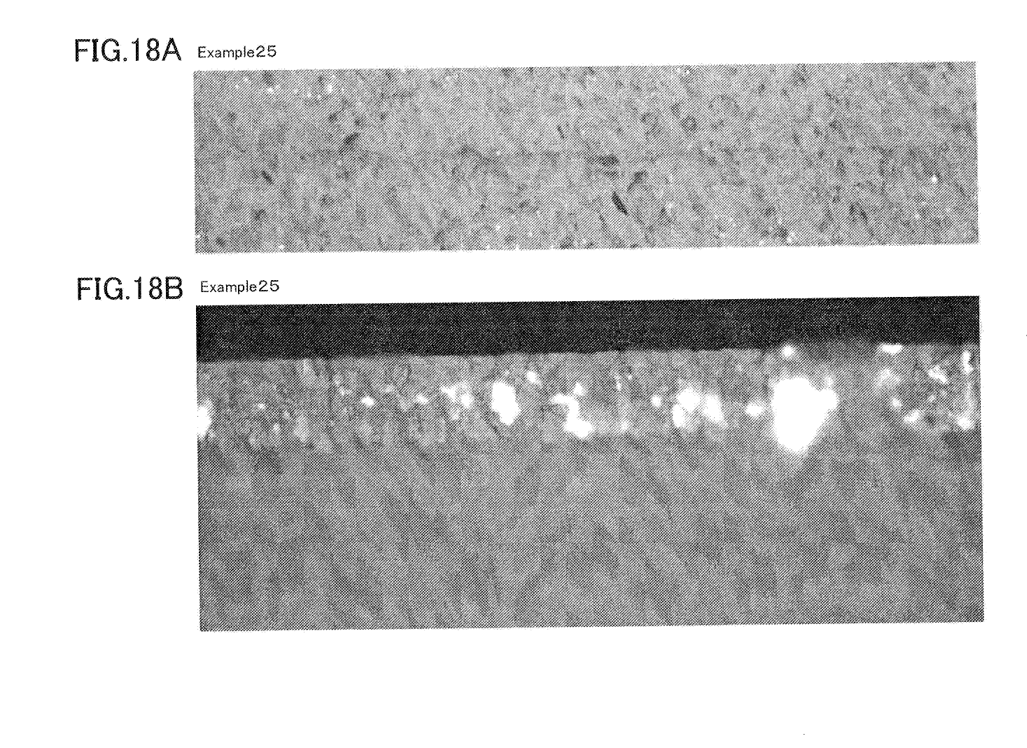

A result of laser dicing is illustrated in FIG. 18. FIG. 18A is an optical photograph of the top of the substrate and FIG. 18B is an optical photograph of the cross-section of the substrate. As illustrated in FIGS. 18A and 18B, even when the crystal substrate is used as the substrate, the reforming layer is formed therein and the crack to be continuous on the surface of the substrate may be formed. As a result, linear fracturing may be performed by the breaker.

### Example 26

Laser dicing is performed by a method disclosed in the embodiment, under the conditions below.

Substrate: quartz glass substrate, thickness of substrate of 500 μm

Laser light source: Nd:YVO₄ laser

Wavelength: 532 nm

Irradiation energy: 150 mW

Laser frequency: 100 KHz

Number of irradiated optical pulses (P1): 3

Number of non-irradiated optical pulses (P2): 3

Velocity of stage: 5 mm/sec

Depth of processing point: Approximately 12 μm from the surface of the substrate.

The substrate has a reed shape having a width of approximately 5 mm and the crack is formed by irradiating the pulse laser beam vertically in an extension direction of a reed. After the crack is formed, the substrate is fractured by using the breaker.

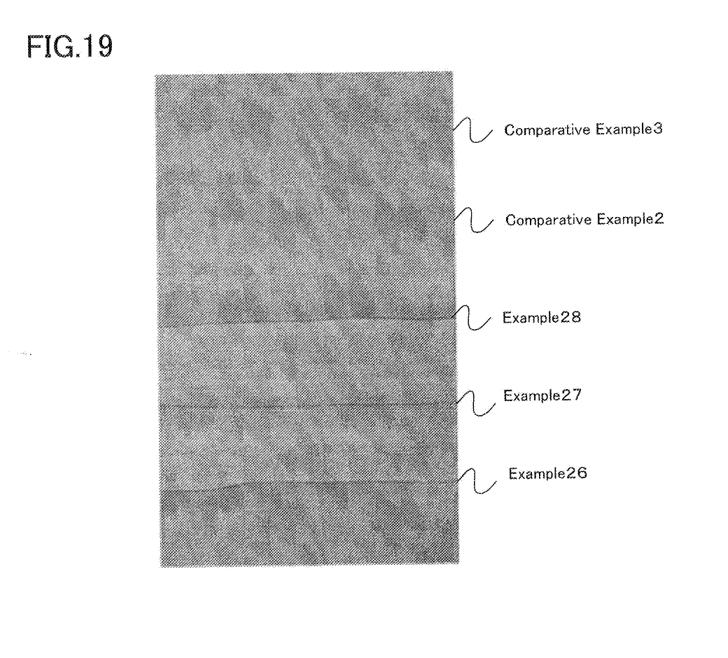

A result of laser dicing is illustrated in FIG. 19. FIG. 19 is an optical photograph of the top of the substrate.

### Example 27

Laser dicing is performed in the same method as in Example 26 except that the processing point depth is spaced apart from the surface of the substrate by approximately 14 μm. A result of laser dicing is illustrated in FIG. 19.

### Example 28

Laser dicing is performed in the same method as in Example 26 except that the processing point depth is spaced apart from the surface of the substrate by approximately 16 μm. A result of laser dicing is illustrated in FIG. 19.

### Comparative Example 2

Laser dicing is performed in the same method as in Example 26 except that the processing point depth is spaced apart from the surface of the substrate by approximately 18 μm. A result of laser dicing is illustrated in FIG. 19.

### Comparative Example 3

Laser dicing is performed in the same method as in Example 26 except that the processing point depth is spaced apart from the surface of the substrate by approximately 20 μm. A result of laser dicing is illustrated in FIG. 19.

As illustrated in FIG. 19, even when the quartz glass substrate is used as the substrate, the crack to be continuous on the surface of the substrate may be formed, under the conditions of Example 26 to Example 28. As a result, linear fracturing may be performed by the breaker. In particular, in Example 27, the crack having the highest linearity may be formed and fracturing may be performed with high linearity. In Comparative Examples 2 and 3, the condition is not optimized and the crack to be continuous on the surface of the substrate is not formed.

Hereinabove, from Example 25 to Example 28, it is apparent that, even though the substrate is changed from the sapphire substrate to the crystal substrate or the quartz glass substrate, when irradiation and non-irradiation of the pulse laser beam are synchronized with the pulse laser beam in addition to the irradiation energy of the pulse laser beam, the processing point depth of the pulse laser beam, and the like, irradiation and non-irradiation are controlled in synchronization with the clock signal for the same processing control and are switched by the unit of the optical pulse, and as a result, the optimal fracture characteristic may be achieved.

What is claimed is:

1. A laser dicing method, comprising:
loading a substrate on a stage;
generating a clock signal;
emitting a pulse laser beam synchronized to the clock signal;
relatively shifting the substrate and the pulse laser beam;
switching by the unit of an optical pulse irradiation and non-irradiation of the pulse laser beam to the substrate by controlling passage and interruption of the pulse laser beam by using a pulse picker in synchronization with the clock signal; and
forming a crack reaching the surface of the substrate on the substrate,
wherein the crack is formed to be continuous on the surface of the substrate by controlling irradiation energy of the pulse laser beam, a processing point depth of the pulse laser beam, and the lengths of an irradiation region and a non-irradiation region of the pulse laser beam.

2. The laser dicing method according to claim 1, wherein the crack is formed on the surface of the substrate substantially linearly.

3. The laser dicing method according to claim 1, wherein the position of the substrate and an operation start position of the pulse picker are synchronized with each other.

4. The laser dicing method according to claim 1, wherein the substrate is a sapphire substrate, a crystal sapphire, or a glass substrate.

5. The laser dicing method according to claim 3, wherein the stage is shifted in synchronization with the clock signal to relatively shift the substrate and the pulse laser beam.
